(19) United States
(12) Patent Application Publication
(10) Pub. No.: US 2004/0059593 A1
(43) Pub. Date: Mar. 25, 2004

(54) Method of operating a micro-environment within a commercial complex to promote sales of particular products and services offered by participating retail merchants

(76) Inventor: Roy Higgs, Severna Park, MD (US)

Correspondence Address: Patent Office of J. John Shimazaki, P.O. Box 650741, Sterling, VA, 20165, US

(21) Appl. No.: 10/657,693

(22) Filed: Sep. 8, 2003

Related U.S. Application Data
(60) Provisional application No. 60/408,334, filed on Sep. 6, 2002.

(51) Int. Cl. G06F 17/60

(52) U.S. Cl. 705/1

(57) ABSTRACT

The invention relates to a method that can be used by mall developers to attract the right kind of retail merchants, and that retail merchants can use to promote the particular goods and services that they sell. The method involves developing and operating a microenvironment within a shopping mall or commercial complex having a theme that relates to the particular goods and/or services offered for sale by the participating merchants. The microenvironment can be provided with one or more activities as a source of entertainment to attract customers to the mall or complex, and to promote the particular products and services offered for sale by the participating merchants.

### RELATED APPLICATIONS

This application claims priority from U.S. Provisional Application Serial No. 60/408,334, filed on Sep. 6, 2002.

### FIELD OF THE INVENTION

The present invention relates to business methods, and in particular, to a method of operating a microenvironment within a commercial complex, such as a shopping mall, to provide entertainment and/or other activities designed to promote sales of particular products and services offered by participating retail merchants.

### BACKGROUND OF THE INVENTION

While there are many large mass retail merchandize stores, such as Walmart®, Target®, Kmart®, etc., and large department stores, such as Macy's®, Bloomingdales®, Hechts®, etc., that sell a wide variety of consumer goods, many smaller retail merchants have to specialize to set themselves apart from the rest. For example, in shopping malls across the country, there are many specialty stores that sell specific types of consumer goods, such as clothing, shoes, books, furniture, cookware, dishes, sporting goods, toys, etc. These establishments specialize in and deal with particular goods and are able to provide merchandize of a specialized nature as a means of attracting customers to their stores.

Developing a marketing strategy that includes specialization often includes promoting products and services in a unique way to focus on the differences between the specialized products and other more general products. Many such retail establishments spend considerable time, money and effort creating concepts and images for branding purposes, and then conveying those concepts and images to consumers through advertising and other marketing methods to attract consumers to their stores. This can be done, for example, by using the decor of the store itself, including the style, design, colors, etc., so that consumers who are interested in those styles, etc., will be drawn to the establishment. In this respect, the decor is often designed to be compatible with the products and services that are offered at the establishment.

Another method that some retail establishments use, in addition to specialization, is offering activities that are related to the products and services offered by the stores as a means of attracting new customers. For example, a cookware store might offer cooking classes, and an arts supply store might offer art classes. Stores have also begun to provide entertainment to attract customers. For example, McDonalds® has children's playgrounds to get kids to come to their restaurants. Rain Forest Cafe® and Chuck E Cheese® have animated characters and other entertainment to attract consumers. Sporting goods stores, such as Galyans®, have rock climbing walls, while others have indoor skiing facilities.

Entire shopping malls can also provide activities and entertainment to attract customers. For example, movie theaters are commonly found in large shopping malls to attract customers to the malls. Some large malls even have built roller coaster rides and other attractions, while others have built-in playgrounds, and put on free concerts, exhibits, and galleries, etc. During Christmas time, malls typically have extensive decorations, Christmas trees, and Santa Claus, all designed to attract customers.

One of the drawbacks of previous attempts in shopping malls like these have been that the activities and entertainment have not necessarily been targeted to promote the particular products and services that are offered for sale by the retail merchants located at the mall. In many cases, the entertainment is provided generally to attract people to the mall, but not necessarily to promote any particular goods or services of a particular retail merchant. Accordingly, consumers often simply come for the entertainment or activity, and end up not buying the products and services offered by the retail merchants that pay rent at the mall. Moreover, while some large retail stores that are not located in shopping malls are able to provide promotional activities in their own stores, many smaller retail merchants that occupy space in shopping malls often don't have the resources or the space to offer them on their own.

What is needed, therefore, is a method of operating a micro-environment within a commercial complex, such as a shopping mall, designed to provide activities and entertainment that are specifically targeted to the products and services being offered for sale by the participating retail merchants that occupy and rent space there, wherein the activities and entertainment can attract customers to the commercial complex, but also help promote sales of the specific products and services that they offer.

### SUMMARY OF INVENTION

The present invention relates to a method of promoting sales of particular goods and services offered by particular retail establishments within a commercial complex, such as a shopping mall, comprising the use of a micro-environment within the complex having a theme associated with the particular goods and services offered by the participating retail merchants. The invention contemplates that the micro-environment can be located within the shopping mall adjacent or in close proximity to the participating retail merchants, and that at least one activity or entertainment can be provided within the micro-environment with a theme relating to the particular goods and services offered by the retail establishments. This way, the activity or activities can be designed to not only entertain and attract customers to the mall, but also to provide a means of promoting the particular goods and services offered by the participating retail establishments.

An example of the present invention relates to a micro-environment within a shopping mall having a theme that relates to the products and services of at least two retail merchants located in or adjacent the micro-environment. For example, in a shopping mall, a micro-environment can be developed in connection with a theme relating to sports and outdoor activities, wherein in or adjacent to the microenvironment, there can be located a sporting goods store, an outdoor clothing store, and other specialty stores that sell various outdoor gear and equipment, such as skate boards, surf boards, snow boards, sunglasses, beachwear, etc. Likewise, the microenvironment can comprise of, without limitation, any one or more of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, etc. In such case, the sporting goods store, as well as the specialty stores, can have their sports equipment and other products tried and tested by consumers in the microenvironment. Retail merchants can use the microenvironment to enable specific products and services to be tried and tested there, while consumers can participate in and enjoy the activities.

A merchant that offers services could also be located in or adjacent the microenvironment, wherein the services can be promoted by the activity. For example, in connection with the above sports activities, an outdoor excursion guide business can be provided, wherein lessons and other information relating to the activities can be provided as a means of attracting customers to the guide business. That is, an employee of the business can offer, for instance, rock-climbing lessons at the rock-climbing wall, as a means of promoting their rock climbing excursion adventures.

The microenvironment can also be altered during different seasons. In the above example, the rock climbing wall, putting green, indoor golf driving net, swim exercise pool, and underwater diving tank, can be offered during the summer months, while the simulated skiing and ice skating rink can be offered during the winter months. This way, the microenvironment can be geared specifically towards the particular goods and services that are likely to be popular during any given time of year.

The present invention also contemplates that mall developers can use the microenvironment as a means of attracting the right kind of retail merchants to the mall. That is, in any development, mall developers have a strong interest in attracting the right kind of retail merchants to occupy space there, since the quality of the tenants will largely dictate the quality of the overall mall, and shopping experience, and therefore, the success of the development. By being able to offer a microenvironment within a shopping mall specifically designed with a theme that relates to the particular products and services that are being offered for sale by the desired retail merchants, mall developers can attract and encourage those merchants to occupy space at the mall. The merchants would presumably have an interest in using the microenvironment to promote their products and services, since it can be specifically tailored to their businesses.

### BRIEF DESCRIPTION OF THE DRAWINGS

FIG. 1 shows an example of an indoor/outdoor application of a microenvironment of the present invention in a shopping mall environment.

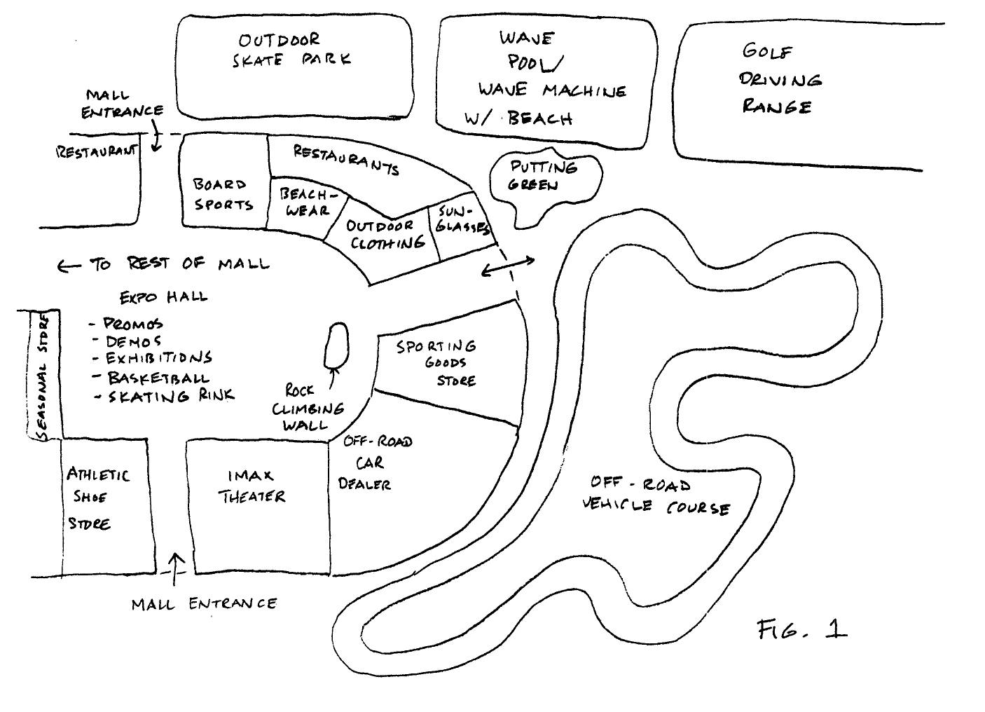

### DETAILED DESCRIPTION OF THE INVENTION

The development of a shopping mall typically involves a complex series of events that must be coordinated for the development to be successful. To the average consumer, there is no indication on the outside of the enormous amount of time, effort and resources that are required to enable a shopping mall to be developed and operated.

In the beginning, there must be a vision, and enough talent and resources to get the project off the ground. The initial steps, in many cases, begin with the mall concept, as well as the selection of a location. In this respect, marketing studies are often performed to determine the best location, as well as what kinds of retail establishments should occupy space at the mall. These decisions are often based on geographical and demographical marketing information about the kinds of communities that will eventually be located near the mall, as well as the economic statuses of the consumers who will eventually shop there. Various studies relating to the economic conditions and wealth statuses of the area, including future prospects for employment and growth, are likely to be conducted. Specific studies relating to various zoning and density requirements, ordinances, easements, environmental impacts, availability of utilities, transportation, roads and services, land use restrictions, etc. will also have to be considered. Permission from government agencies and boards, as well as political groups, are also often required to obtain approval.

These are just some of the issues that must be dealt with to develop a shopping mall. There are also a number of financial issues, including how the cost of the project is going to be financed and by whom. This could involve obtaining loans from financial institutions or obtaining funding from investors, whether they are individuals or companies. When obtaining money from investors, decisions will often have to be made, and disclosures will often have to be given, with respect to how the costs and benefits will be apportioned and spent. Other decisions that have to be made include deciding who the contractors and sub-contractors are going to be, which can involve obtaining quotes and bidding the project to potential contractors. Specifications, in such case, such as designed by a design firm responsible for the architectural and engineering drawings and designs, as well as city and regional planning issues, will also have to be addressed.

Another issue that mall developers have to deal with involves selecting the right retail merchants that are going to occupy and lease space at the mall. This process can be complicated by the fact that negotiations often have to be entered into with respect to each prospective tenant, and each one presumably has its own interests and concerns that must be considered and discussed. Some prospective tenants may be essential to the mall, such as large department stores, which may be the focus of the initial development efforts. For example, in any given mall, the fact that Nordstrum, Macy's, Saxs Fifth Avenue, etc., might agree to occupy space at the mall could change the entire complexion of the development, both from the standpoint of the size and scope of construction, as well as who the other tenants will be. As is often the case, a decision by one tenant may end up being the reason that another tenant might agree to occupy space there. Various agreements would also have to be entered into in order to assure that the right kinds of tenants will occupy space at the mall. The decision whether to occupy space at a particular mall, and the extent of their involvement, will ultimately be decided upon by the retail merchants themselves.

Within this context, mall developers have a number of important options and decisions to make concerning the development of the mall. In this respect, they are often required to deal with the prospect that they can't always control every factor that relates to the mall's development. The present invention contemplates that mall developers will be able to attract prospective and desirable retail tenants by providing a microenvironment within the mall specifically designed to provide activities and entertainment that will help promote sales of the particular goods and services being offered for sale by the participating retail merchants. They are also designed to be entertaining and enjoyable to consumers so as to attract customers to the mall and to the stores.

For example, if mall developers want to have a sporting goods store located at the mall, they can improve the chances of attracting the right kind of sporting goods store by offering a package that includes the construction of a micro-environment within the mall designed to promote the specific kinds of goods and services to be sold by the desired store. An example might be the construction of a rock climbing wall inside the mall located adjacent where the sporting goods store will be located, wherein consumers who want to climb the wall will be exposed to a wide variety of products, such as rock climbing gear, shoes, ropes, etc., that are offered by the store. This way, customers may choose to come to the mall to try the rock-climbing wall, and end up buying some of the products offered by the adjacent store. This is also true of having a golf driving range and putting greens adjacent the sporting goods store, wherein consumers can try out the latest types of golf clubs before deciding which ones to buy.

Additional retail merchants that stand to benefit from the activity, such as outdoor clothing and excursion guide businesses, and other specialty product stores, can also be located in or adjacent the micro-environment, so that by operating the activity, the mall can help promote the specific products and services offered for sale by the participating retail merchants. The fact that the developers can offer this type of package means that the right kind of retail merchants will have more of an incentive to occupy space at the mall.

In one aspect, the present invention relates to a method of promoting sales of goods and services offered by particular retail merchants within a commercial complex, such as a shopping mall, and contemplates creating a micro-environment within the complex having a theme associated with the goods and services offered by the participating retail establishments. The invention contemplates that the microenvironment can be located within the shopping mall, including indoor and outdoor areas, adjacent or in close proximity to the participating retail merchants, so that an immediate association can be made in the minds of the consumers between the activity and the merchants. For example, at least one activity can be provided within the microenvironment that matches a theme relating to the particular goods and services offered by the merchants. This way, the activity can be designed to not only provide entertainment and attract customers to the mall, but it can also provide a means by which the participating retail merchants can promote sales of particular goods and services that they offer.

An example is a micro-environment having a theme that relates to at least two retail merchants located at the mall, i.e., in or adjacent the micro-environment. For example, in a shopping mall, the micro-environment can have a sports or outdoor theme, wherein in or adjacent the micro-environment, there can be a sporting goods store, an outdoor clothing store, and specialty stores that are tailored to specific activities located in the micro-environment. The activities provided in the microenvironment can, in turn, be one or more of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, etc. In this respect, the invention contemplates that specialty stores, such as those that sell skate boards, snow boards, surf boards, sunglasses, beachwear, and other paraphernalia, could also be located in or adjacent the micro-environment. In such case, the sporting goods store can allow their sports equipment to be used and tested by consumers in the microenvironment, while specialty stores can rent or otherwise allow customers to try their devices and products.

Merchants that offer services can also be located adjacent the activity, wherein the services can be promoted by the activity. For example, in connection with the above-identified activities, an outdoor excursion guide business can be located in close proximity to the activity, wherein lessons and other information relating to the activities can be provided as a means of promoting the business. An employee of the business can offer, for instance, rock-climbing lessons at the rock-climbing wall as a means of promoting their rock-climbing excursion adventures.

The microenvironment can also include exterior areas of the mall property. For example, in the above example, a variety of outdoor activities can be provided in an outdoor area adjacent the participating retail merchants. For example, the mall could incorporate an outdoor off-road vehicle course, such as the one described in pending provisional application No. 60/426,380, filed by Applicant on Nov. 15, 2002, which is incorporated herein by reference in its entirety. It could also have an outdoor skating rink, skate park, a golf driving range, a putting green, as well as surfing machines and wave pools, etc. Any one of the activities described above, as well as other activities, can be provided as part of an outdoor portion of the microenvironment. In this respect, the present invention contemplates that the microenvironment can be located all indoors, all outdoors, or some indoors and outdoors. Depending on the climate where the mall is located, all of the activities could be provided outdoors if desired.

The microenvironment can also be altered during different seasons. In the above example, the golf driving range, putting green, wave pool, skate park, etc., can be offered during the summer months. On the other hand, the simulated skiing and ice skating rink can be offered during the winter months. This way, the microenvironment can be geared specifically towards the particular goods and services that are likely to be popular during any given time of year. Any of various activities can be rotated throughout the seasons depending on what kinds of goods and services are to be promoted.

While the example of a sports and outdoor activity theme is provided, the present invention contemplates that virtually any activity that is consistent with a chosen theme that relates to the particular products and services being offered for sale by the participating retail merchants can be provided. Other examples include: fashion design and make-up activities in close proximity to clothing and beauty supply stores; concerts and musical activities in close proximity to stores that sell cd's, tapes and musical instruments; cooking and tasting displays in close proximity to cookware and unique food stores, etc.

The present invention contemplates that the microenvironment can be independently operated by a separate business operated for profit within the shopping mall, or it can be operated by the shopping mall, or by the retail merchants that occupy space at the mall, individually or collectively, depending on what the merchants want to do.

Another aspect of the invention is that the retail merchants that occupy space in the microenvironment can be those that are not ordinarily retail merchants, but product manufacturers and producers with recognizable brand names that normally sell their products through other retail stores. For example, a company that makes and sells designer sunglasses might ordinarily sell their products through department stores and other specialty sunglass stores. What the microenvironment allows the mall developer to do, however, is to attract these manufacturers and producers that would not ordinarily operate a retail establishment and give them an incentive to occupy retail space at the mall. One of the incentives is that the activities assigned to the microenvironment can help promote their particular products and services. Another is that the producer of the product stands to earn the full mark-up price on each product sold, i.e., by avoiding the retail margin that would otherwise be given to the retail merchant.

The invention has been described in terms of the preferred embodiments discussed above, but it is contemplated that other embodiments not specifically discussed are also within the contemplation and scope of the present invention.

What is claimed is:

1. A method of promoting sales of goods and/or services by pre-selected retail merchants within a shopping mall, comprising:
providing a microenvironment within said shopping mall having a theme associated with the goods and/or services sold by at least two of said retail merchants;
locating said at least two of said retail merchants on the property of said shopping mall in or adjacent said microenvironment; and
providing at least one activity within said micro-environment having a theme designed to help promote the particular goods and/or services offered for sale by said at least two of said retail merchants, wherein said activity is designed to provide entertainment and/or activities relating to said particular goods and/or services, and to attract customers to said at least two of said retail merchants.

2. The method of claim 1, wherein said at least one activity enables said particular goods and/or services offered by at least one of said at least two retail merchants to be tried and/or tested by consumers and/or demonstrated in said micro-environment.

3. The method of claim 1, wherein said microenvironment is located in a common area within an indoor and/or outdoor area of said shopping mall.

4. The method of claim 1, wherein said theme relates to an activity taken from the group consisting of the following:
a. sports and other outdoor activities, wherein said at least two of said retail establishments comprises at least one store that sells and/or rents goods relating to said sports and other outdoor activities;
b. fashion design and make-up activities, wherein said at least two of said retail establishments comprises at least one store that sells goods relating to said fashion design and make-up activities;
c. concerts and musical activities, wherein said at least two of said retail establishments comprises at least one store that sells goods relating to said concerts and musical activities;
d. cooking and tasting displays, wherein said at least two of said retail establishments comprises at least one store that sells goods relating to said cooking and tasting display activities.

5. The method of claim 1, wherein said at least one activity is independently operated by a separate business operated within said shopping mall, operated by said shopping mall, or operated individually or collectively by one or more of said at least two retail merchants.

6. The method of claim 1, wherein said at least one activity within said microenvironment is altered during the year to emphasize themes associated with seasonal activities.

7. The method of claim 1, wherein said at least one activity comprises one or more activity taken from the group consisting of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, fashion design and make-up activities, concerts or musical activities, and cooking and tasting activities and displays.

8. A method of promoting sales of particular goods and/or services by at least one retail establishment in a shopping center, comprising:
in a conventional shopping center having a plurality of retail establishments, providing a microenvironment within said shopping center having a theme associated with said particular goods and/or services of said at least one of said retail establishments;
locating said at least one of said retail establishments within a common area of said shopping center in or adjacent to said micro-environment; and
providing at least one activity within said micro-environment consistent with said theme to help promote sales of said particular goods and/or services offered by said at least one of said retail establishments.

9. The method of claim 8, wherein said at least one activity enables said particular goods and/or services offered by said at least one of said retail establishments to be tried and/or tested by and/or demonstrated on behalf of consumers.

10. The method of claim 8, wherein said microenvironment is located in a common area within an indoor and/or outdoor area of said shopping mall.

11. The method of claim 10, wherein said theme relates to an activity taken from the group consisting of the following:
a. sports and other outdoor activities, wherein said at least one of said retail establishments comprises at least one store that sells and/or rents goods relating to said sports and other outdoor activities;
b. fashion design and make-up activities, wherein said at least one of said retail establishments comprises at least one store that sells goods relating to said fashion design and make-up activities;
c. concerts and musical activities, wherein said at least one of said retail establishments comprises at least one store that sells goods relating to said concerts and musical activities;
d. cooking and tasting displays, wherein said at least one of said retail establishments comprises at least one store that sells goods relating to said cooking and tasting display activities.

12. The method of claim 8, wherein said at least one activity is independently operated by a separate business operated within said shopping mall, operated by said shopping mall, or operated individually or collectively by one or more of said at least one of said retail establishments.

13. The method of claim 8, wherein said at least one activity within said microenvironment is altered during the year to emphasize themes associated with seasonal activities.

14. The method of claim 8, wherein said at least one activity is taken from the group consisting of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, fashion design and make-up activities, concerts or musical activities, and cooking and tasting activities and displays.

15. A method of attracting retail merchants to occupy space at a shopping mall or commercial complex, comprising:
developing or having developed said shopping mall or complex having a plurality of retail spaces for establishments to lease;
developing or having developed a microenvironment within a common area of said shopping mall or complex;
developing or having developed a theme and at least one activity for said microenvironment related to said theme;
arranging for the location and operation of at least one retail establishment in or adjacent said micro-environment within said shopping mall or complex, wherein said at least one retail establishment can offer particular goods and/or services associated with said theme; and
arranging for the operation of said at least one activity in said microenvironment in a manner that serves to promote said particular goods and/or services offered for sale by said at least one retail establishment.

16. The method of claim 15, wherein the step of developing or having developed at least one activity comprises developing or having developed an activity which enables consumers to try and/or test and/or have demonstrated the particular goods and/or services offered for sale by said at least one retail establishment.

17. The method of claim 15, wherein more than one microenvironment is developed within said shopping mall or complex.

18. The method of claim 15, wherein said at least one activity is independently operated by a separate business operated within said shopping mall, operated by said shopping mall, or operated by one or more of said at least one retail establishment.

19. The method of claim 15, wherein said at least one activity within said microenvironment is altered during the year to emphasize themes associated with seasonal activities.
